(19) United States
(12) Patent Application Publication
(10) Pub. No.: US 2024/0040669 A1
(43) Pub. Date: Feb. 1, 2024

(54) TRANSPARENT HEATING FILM AND HEATING GLASS

(71) Applicant: SHINE OPTOELECTRONICS (KUNSHAN) CO., LTD., Kunshan (CN)

(72) Inventors: Sheng ZHANG, Kunshan (CN); Zhikui HUANG, Kunshan (CN); Lixiang LIU, Kunshan (CN); Yi HUANG, Kunshan (CN)

(73) Assignee: SHINE OPTOELECTRONICS (KUNSHAN) CO., LTD., Kunshan (CN)

(21) Appl. No.: 18/487,222

(22) Filed: Oct. 16, 2023

Related U.S. Application Data
(63) Continuation of application No. PCT/CN2022/082915, filed on Mar. 25, 2022.

(30) Foreign Application Priority Data
Apr. 28, 2021 (CN) 202110466044.3

(51) Int. Cl. H05B 3/34

(52) U.S. Cl. CPC H05B 3/34; H05B 2203/008

(57) ABSTRACT

Disclosed are a transparent heating film and a heating glass including the transparent heating film. The transparent heating film includes a transparent supporting body, a conductive grid, and a penetration window. A side of the transparent supporting body is provided with a plurality of trenches interconnected to each other in a grid shape; the conductive grid is formed by filling the plurality of trenches with a conductive material; and the penetration window is located between and partitioned with the conductive grid. The penetration window located between the conductive grid may disrupt or weaken a shielding effect of the conductive grid, thereby facilitating penetration of a signal.

### CROSS-REFERENCE TO RELATED APPLICATIONS

This application is a continuation of International Application No. PCT/CN2022/082915, filed on Mar. 25, 2022, which claims priority to Chinese Patent Application No. 202110466044.3, filed on Apr. 28, 2021. The disclosures of the aforementioned applications are hereby incorporated by reference in their entireties.

### TECHNICAL FIELD

The present application relates to the field of heating technologies, and in particular, to a transparent heating film and a heating glass.

### BACKGROUND

A transparent heating film/glass is mainly used in the fields of transportation, architecture and the like. The transparent heating film/glass is disposed on an inner side and an outer side of window glasses to defrost, defog and remove rainwater. Compared with a traditional non-perspective heating product, generally a good transmittance is required for the transparent heating film/glass. In many practical scenarios, the transmittance is required to be above 80%-90%, so as to ensure a better visual effect. However, with a gradual improvement in transmittance index, a conductivity property may be affected, thereby reducing heating efficiency of the transparent heating film/glass. Meanwhile, with popularization of 3G/4G/5G mobile phones, it is required by more applications that a heating film should not have an obvious shielding effect on a mobile phone signal, to avoid an occurrence of a “signal darkroom”.

### SUMMARY

According to research and analysis, Applicant found that currently, a transparent heating film/glass mainly includes a laminated glass with metal wires, an indium tin oxide (ITO) coated glass and a low-emissivity (LOW-E) silver coated film/glass and other products. Therein, a diameter of a metal wire of the laminated glass with metal wires is in the order of tens of micron, and spacing between the metal wires is large, leading to unevenness of heating and having an effect on observation of a naked eye on an object outside a window. For products such as an ITO coated film, a LOW-E silver coated film and the like, transmittance and conductivity are mutually restricted, therefore a heating speed is limited by the transmittance, Meanwhile, due to a fact that a signal may not penetrate a homogeneous coating, a shielding effect on the mobile phone signal may be greater, thereby restricting popularization of the heating film.

Based on this, the present disclosure provides a transparent heating film, including: a transparent supporting body, where a side of the transparent supporting body is provided with a plurality of trenches interconnected to each other in a grid shape; a conductive grid, where the conductive grid is formed by filling the plurality of trenches with a conductive material; and at least one penetration window, located between and partitioned with the conductive grid.

In an embodiment, the at least one penetration window includes a plurality of penetration windows, and the plurality of penetration windows are randomly or regularly distributed between the conductive grid.

In an embodiment, the plurality of penetration windows are in one or more shapes of a triangle, a polygon, an S shape, and a circle

In an embodiment, a minimum side length and/or a minimum width of the penetration window is greater than or equal to 1 mm.

In an embodiment, a width of the penetration window ranges from 1 mm to 10 cm.

In an embodiment, the penetration window is configured to be blank inside.

In an embodiment, the penetration window is provided with a color matching grid, and the color matching grid is not connected to the conductive grid.

In an embodiment, the transparent supporting body is provided with a groove, the groove is filled with a color matching material to form the color matching grid, and a grid line of the color matching grid is disconnected to form an open circuit.

In an embodiment, an average aperture of the conductive grid ranges from 10 μm to 1000 μm, and an average aperture of the color matching grid ranges from 10 μm to 1000 μm.

In an embodiment, a depth-to-width ratio of the trench is greater than or equal to 2.

In an embodiment, a width of the trench ranges from 500 nm to 10 μm, and a depth of the trench ranges from 1 μm to 20 μm.

In an embodiment, a part of the conductive grid is configured as an electrode; or the transparent supporting body further includes a line-shaped trench, and the line-shaped trench is filled with the conductive material to form the electrode electrically connected to the conductive grid; or the transparent heating film further includes the electrode stacked on the transparent supporting body and electrically connected to the conductive grid.

In an embodiment, the transparent supporting body is a substrate layer, or the transparent heating film further includes the substrate layer, and the transparent supporting body is stacked on the substrate layer.

The present disclosure further provides another transparent heating film, including: a transparent supporting body, where the transparent supporting body is provided with a trench and a groove, the trench is not interconnected to the groove, and the trench is in a grid shape; a conductive grid, where the trench is filled with a conductive material to form the conductive grid; a color matching grid, where the groove is filled with a color matching material to form the color matching grid, and the conductive grid is not connected to the color matching grid; and an electrode lead wire, where the electrode lead wire includes an electrode electrically connected to the conductive grid, and a lead wire electrically connected to the electrode.

In an embodiment, a penetration window is formed by the color matching grid, and a plurality of penetration windows are distributed between the conductive grid.

In an embodiment, a depth-to-width ratio of the trench is greater than or equal to 2, and an average aperture of the conductive grid ranges from 10 μm to 1000 μm.

In an embodiment, the electrode includes a first electrode and a second electrode disposed opposite to each other, the electrode is in a line or arc shape, and the lead wire includes first lead wires located at two ends of the first electrode respectively, and second lead wires located at two ends of the second electrode respectively.

The present disclosure further provides another transparent heating film, including: a transparent supporting body, where a side of the transparent supporting body is provided with a trench in a grid shape; a conductive grid, where the trench is filled with a conductive material to form the conductive grid; an electrode, electrically connected to the conductive grid; and a penetration window, where at least one of the penetration window is distributed between the conductive grid, the penetration window is configured to be blank inside or configured with a color matching grid disconnected to the conductive grid, and a minimum side length/a minimum width of the penetration window is greater than or equal to 1 mm.

In an embodiment, the penetration window is in a shape of a triangular, a polygonal, an S-shaped, or a circular.

The present disclosure further provides a heating glass, including: a glass and the transparent heating film as described above disposed on the glass.

In an embodiment, the glass is configured to be a layer of glass and the transparent heating film is disposed on either side of the glass, or the glass is configured to be two layers of glass and the transparent heating film is disposed between the two layers of the glass.

According to the transparent heating film and the heating glass provided in the embodiments of the present disclosure, a conductive grid is used for heating. A conductive material is used to form the conductive grid in a grid shape, and no conductive material is provided in grid holes of the conductive grid, so that the transparent heating film may have better effects of high transmittance, low square resistance and rapid heating. The grid holes may allow more light to penetrate and may not affect observation and work of an inner personnel. And the conductive grid may achieve a rapid heating effect of reaching over 80° C. within 5-10 seconds. Meanwhile, a penetration window is provided in the conductive grid to facilitate penetration of a signal, so that usage of a communication device may not be affected.

### BRIEF DESCRIPTION OF THE DRAWINGS

FIG. 1 is a cross-sectional view of a transparent heating film according to the present disclosure.

FIG. 2 is a plan view of FIG. 1.

FIG. 3 is another plan view of FIG. 2.

FIG. 4 is still another plan view of FIG. 2.

FIG. 5 is another plan view of a transparent heating film according to the present disclosure.

FIG. 6 is still another plan view of a transparent heating film according to the present disclosure.

FIG. 7 is yet still another plan view of a transparent heating film according to the present disclosure.

FIG. 8 is yet still another plan view of a transparent heating film according to the present disclosure.

FIG. 9 is a cross-sectional view of a heating glass according to the present disclosure.

FIG. 10 is another cross-sectional view of a heating glass according to f the present disclosure.

FIG. 11 is still another cross-sectional view of a heating glass according to the present disclosure.

FIG. 12 is yet still another cross-sectional view of a heating glass according to the present disclosure.

FIG. 13 is yet still another cross-sectional view of a heating glass according to the present disclosure.

### DETAILED DESCRIPTION OF THE EMBODIMENTS

In order to facilitate understanding of the present disclosure, a more comprehensive description of the present disclosure will be provided hereinafter with reference to accompanying drawings. Preferred embodiments of the present disclosure are provided in the accompanying drawings. However, the present disclosure may be implemented in many different forms, and is not limited to the embodiments described below. On the contrary, a purpose of providing the embodiments is to make a more thorough and comprehensive understanding of disclosed content of the present application.

Unless otherwise defined, all technical and scientific terms used herein have the same meaning as commonly understood by a technical personnel belonging to a technical field of the present disclosure. Terms used herein in the specification of the present disclosure are for a purpose of describing particular embodiments only, and are not intended to limit the present disclosure. As used herein, term “and/or” includes any and all combinations of one or more of related listed items.

The present application discloses a transparent heating film, including a transparent supporting body, a conductive grid, and a penetration window. A side of the transparent supporting body is provided with a plurality of trenches interconnected to each other in a grid shape, and the conductive grid is formed by filling the plurality of trenches with a conductive material. The penetration window is located between and partitioned with the conductive grid. The penetration window located between the conductive grid may disrupt or weaken a shielding effect of the conductive grid, thereby facilitating penetration of a signal.

A plurality of penetration windows are randomly or regularly distributed between the conductive grid. In an embodiment, the transparent heating film may be provided with only one penetration window. The penetration window may be configured to be in a random shape, size and position, or configured according to specification. A length of the penetration window is random, and a width of the penetration window is greater than or equal to 1 mm, so as to ensure the penetration of the signal. In another embodiment, the transparent heating film may be provided with a plurality of penetration windows, and each of the plurality of penetration windows may be configured to be in a random shape, size and position, or configured according to specification. The plurality of penetration windows may be in one or more shapes of a triangle, a polygon, an S shape, and a circle. For example, a shape of the plurality of penetration windows is a triangle, and a plurality of triangular penetration windows are arranged on the supporting body in columns. For another example, a shape of the plurality of penetration windows is S shape, and a plurality of S-shaped penetration windows are arranged on the supporting body in rows. Therein, a line width of the S-shaped penetration window is greater than or equal to 1 mm, and a line length of the S-shaped penetration window is configured based on a width of the supporting body, and is not limited here. Certainly, in order to ensure evenness of heating, there should not be a large area without the conductive grid. Therefore, a width of a widest part of the penetration window is configured to be less than or equal to 10 cm, that is, it is appropriate that a width of any position of the penetration window ranges from 1 mm to 10 cm, so that the penetration of a signal and evenness of heating may be ensured.

The penetration window may be configured to be blank inside or configured with a color matching grid, and the color matching grid is not connected to the conductive grid. The penetration window may be configured with no structure inside to be blank. For example, the penetration window may be configured to include only a structure of the supporting body without any groove; or the supporting body in the penetration window may be removed to form a hole, and the hole is filled with a transparent material such as optically clear adhesive (OCA). The penetration window may also provided with a color matching grid, and the color matching grid is not connected to the conductive grid. For example, the transparent supporting body is provided with a groove, and the groove is filled with a color matching material to form the color matching grid. A grid line of the color matching grid is disconnected, that is, grid lines of the color matching grid are not completely communicated and there is a discontinuous point in the grid line. The color matching material may be a same conductive material as that filled in the conductive grid, or may be other non-conductive materials. The trench is not connected to the groove, therefore, when the trench and the groove are filled with the same conductive material, the conductive grid may not be electrically connected to the color matching grid. Moreover, the grid lines of the color matching grid are disconnected to further prevent electrical communication, so as to form an open circuit. Preferably, each grid line of the color matching grid is disconnected.

An average aperture of the conductive grid ranges from 10 μm to 1000 μm. The conductive grid may be a circular grid, a regular polygon grid, an elliptical grid or a random grid, so that the conductive grid has a better property for penetration of a signal and a better transmittance (with a transmittance of 80%-89%), thereby providing more light penetration and avoiding influence on observation and work of a personnel inside a window.

An average aperture of the color matching grid ranges from 10 μm to 1000 μm. Preferably, the average aperture of the color matching grid is consistent with the average aperture of the conductive grid, so that color evenness of the entire transparent conductive film may be ensured and a color difference may not occur to affect visual effects.

In an embodiment, a depth-to-width ratio of the trench is greater than or equal to 2. The width of the trench referred to herein is a width of a grid line of the conductive grid, and the depth of the trench refers to a thickness, in a direction perpendicular to the transparent supporting body, of the grid line. For example, a width of the trench ranges from 500 nm to 10 μm, a depth of the trench ranges from 1 μm to 20 μm, and the depth-to-width ratio of the trench ranges from 2 to 4. In this way, the conductive grid has a low square resistance (0.1-5 Ω/□), and under a same driving power supply (12-24 W), a higher heating power may be achieved, so that a purpose of rapid heating (reaching over 80° C. in 5-10 seconds) may be realized.

The conductive grid of the transparent heating film is electrically connected to a driving power supply through an electrode lead wire. The electrode lead wire includes an electrode and a lead wire electrically connected to the electrode. The electrode is formed by a part of the conductive grid; or the transparent supporting body further includes a line-shaped trench, and the line-shaped trench is filled with a conductive material to form the electrode electrically connected to the conductive grid; or the transparent heating film further includes the electrode stacked on the transparent supporting body and electrically connected to the conductive grid. For example, the electrode may be stacked on the transparent supporting body through screen printing. The transparent heating film includes a first electrode and a second electrode arranged on an upper side and a lower side, or a left side and a right side, of the supporting body. The first electrode and the second electrode are electrically connected to a plurality of lead wires respectively, and the lead wires are used for electrical connection to a power supply system.

The transparent supporting body is a substrate layer, or the transparent heating film further includes a substrate layer and the transparent supporting body is stacked on the substrate layer. The substrate layer is a layer or a composite layer of glass, polyethylene terephthalate (PET), polycarbonate (PC), polyimide (PI), clear polyimide (CPI), or polymethyl methacrylate (PMMA).

The present disclosure further discloses a heating glass, including a glass and a transparent heating film stacked on the glass. The glass is configured to be a layer of glass, and the transparent heating film is disposed on either side of the glass; or the glass is configured to be two layers of glass, and the transparent heating film is disposed between the two layers of the glass. The heating glass is heated by a conductive grid, with effects of high transmittance, high signal penetration, low square resistance and rapid heating, so that more lights are allowed to penetrate and observation and work of an inner personnel may not be affected. And the conductive grid may achieve a rapid heating effect of reaching over 80° C. within 5-10 seconds. Meanwhile, a penetration window is provided in the conductive grid to facilitate penetration of a signal, so that usage of a communication device may not be affected.

In the following, a transparent heating film and a heating glass of the present disclosure will be described with reference to the accompanying drawings.

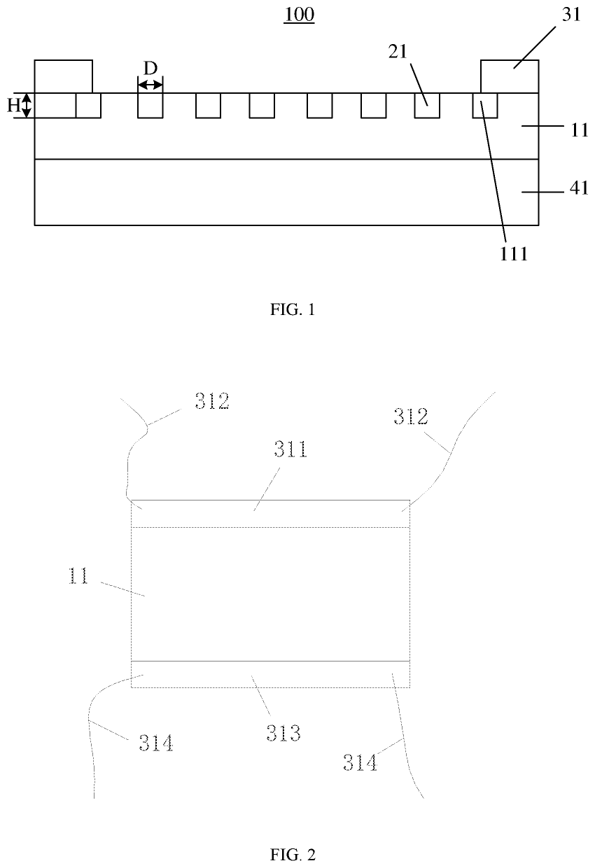

Referring to FIG. 1 and FIG. 2, a transparent heating film 100 includes a transparent supporting body 11, a conductive grid 21, an electrode lead wire 31 and a substrate layer 41. The substrate layer 41 is a transparent flexible PET layer, and a thickness of the transparent flexible PET layer ranges from 23 μm to 188 μm. The transparent supporting body 11 is a transparent imprinting resin disposed on the substrate layer 41, such as a solvent-free ultraviolet curing acrylic resin, or a thermosetting PMMA and the like. Through a method of imprinting and curing, trenches 111 interconnected to each other in a grid shape are formed on the transparent imprinting resin. The trenches 111 are filled with a conductive material to form the conductive grid 21. The electrode lead wire 31 includes a first electrode 311, first lead wires 312, a second electrode 313, and second lead wires 314. The first electrode 311 and the second electrode 313 are respectively arranged at two opposite ends (as shown in FIG. 2) of the transparent supporting body 11 in a manner of screen printing, and the like. Two first lead wires 312 are electrically connected to two ends of the first electrode 311 respectively, and two second lead wires 314 are electrically connected to two ends of the second electrode 312 respectively. The first lead wires 312 and the second lead wires 314 are used to connect to a power supply system (not shown). After the transparent heating film 100 is powered on, a heating power is generated to achieve a purpose of heating which is even and rapid and has a high light transmittance, so that line of sight may not be affected.

A depth of the trench 111 is H, a width of the trench 111 is D, then 1 μm≤H≤20 μm, 500 nm≤D≤10 μm, and H/D≥2:1. Transmittance of the conductive grid 21 may achieve 80%-89%. The conductive grid 21 is a random grid, and an average aperture of the conductive grid 21 ranges from 10 μm to 1000 μm, so that a high rate of signal penetration is achieved with a high transmittance. For example, H is 6 μm, 8 μm, or 12 μm, D is 3 μm, 4 μm, or 5 μm, and the average aperture is 80 μm, 120 μm, or 600 μm.

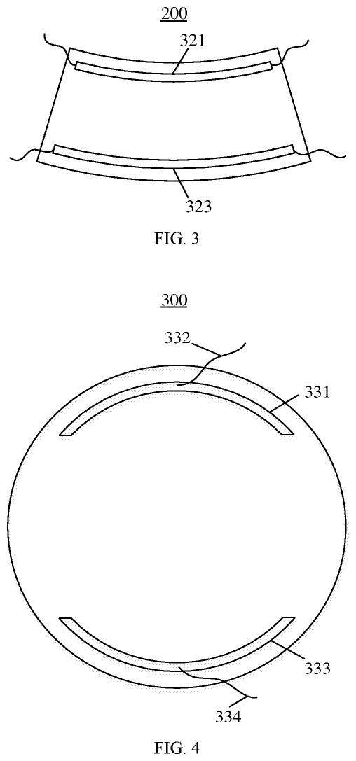

A shape of the transparent heating film 100 may be selected according to an application scenario. The shape of the transparent heating film 100 may be a rectangle and the first electrode 311 and the second electrode 313 are distributed on an upper side and a lower side of the transparent heating film 100 in a straight line shape as shown in FIG. 2. A transparent heating film 200 may alternatively be fan-shaped as shown in FIG. 3. A first electrode 321 and a second electrode 323 of the transparent heating film 200 are arc-shaped, and a length of the first electrode 321 and a length of the second electrode 323 are adapted to an upper side and a lower side respectively. The conductive grid (not shown) is distributed throughout a whole surface. A transparent heating film 300 may alternatively be circular as shown in FIG. 4. A first electrode 331 and a second electrode 333 of the transparent heating film 300 extend in an arc shape along a circumference and are distributed on an upper side and a lower side. A conductive grid (not shown) is distributed throughout a whole surface. The first electrode 331 is electrically connected to a first lead wire 332, and the second electrode 333 is electrically connected to a second lead wire 334.

Referring to FIG. 5, a transparent heating film 400 is provided by another embodiment of the present disclosure. Compared with the transparent heating film 100, the transparent heating film 400 further includes a penetration window 51. The penetration window 51 is located between and partitioned with a conductive grid (not shown). A plurality of penetration windows 51 are provided. In the present embodiment, the plurality of penetration windows 51 extend longitudinally in a strip shape and are horizontally arranged. The penetration window 51 is configured to be blank without a trench, or only a transparent imprinting resin is provided in the penetration window 51. The penetration window 51 has an edge line 511. The edge line 511 may be a solid line that is visually invisible to clearly define a range of the penetration window 51, but does not affect a line of sight, so that transparency of a whole surface is ensured, such as a thin line of screen printing or a thin line filled in a trench. Alternatively, the edge line 511 may be a line that does not actually exist, and the edge line 511 in FIG. 5 is only used as a schematic sign to specify the penetration window and show that the conductive grid is interrupted when the conductive grid extends to the thin line. Alternatively, the edge line 511 may be served by a grid line of the conductive grid. A side width of the penetration window 51 is defined to be W, and a side length of the penetration window 51 is defined to be L. Then, 1 mm≤W≤10 cm and L is adaptively configured according to a width of the transparent conductive film 400, so that a shielding effect of the conductive grid is eliminated or greatly weakened, thereby realizing penetration of a 3G/4G/5G signal and avoiding influence on communication of a mobile phone of a person on one side while ensuring a heating effect of the conductive grid.

In other embodiments, as shown in FIG. 5, a color matching grid (not shown) is provided in the penetration window 51, and the color matching grid is not connected to the conductive grid. For example, a supporting body 11 is provided with a groove, and the groove is filled with a color matching material to form the color matching grid. Preferably, the groove and the trench are simultaneously filled with the conductive material, but the groove is not connected to the trench, and a grid line of the color matching grid is disconnected to form an open circuit to ensure that the grid line of the color matching grid is not electrically connected to the conductive grid. The groove may be formed simultaneously with the trench of a same size; and of course, for an effect of color matching, a width of the grid line of the color matching grid may be greater than a width of the grid line of the conductive grid, so as to compensate for a color difference caused by disconnection of the grid line of the color matching grid. The color matching material may be a conductive material or an insulating material.

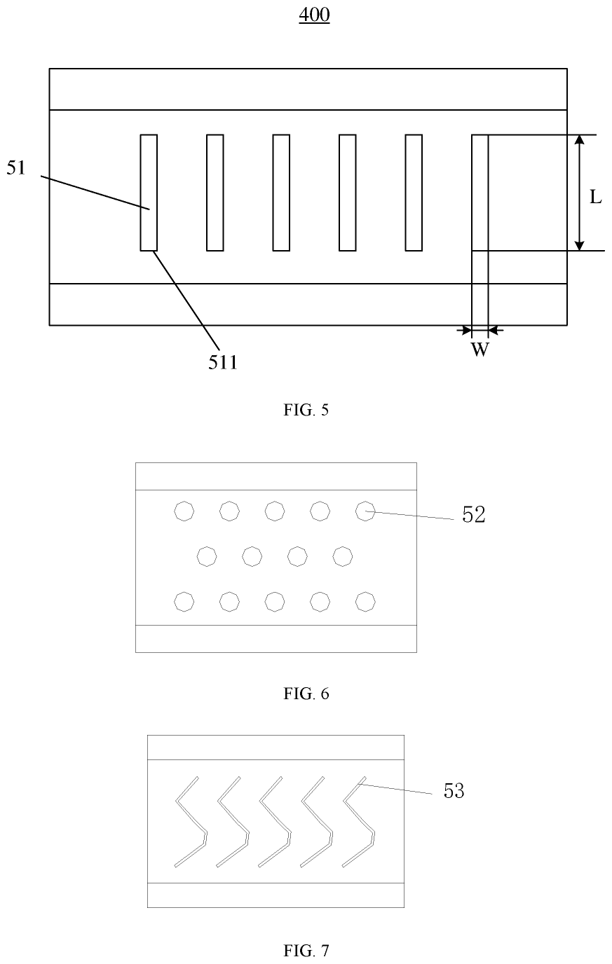

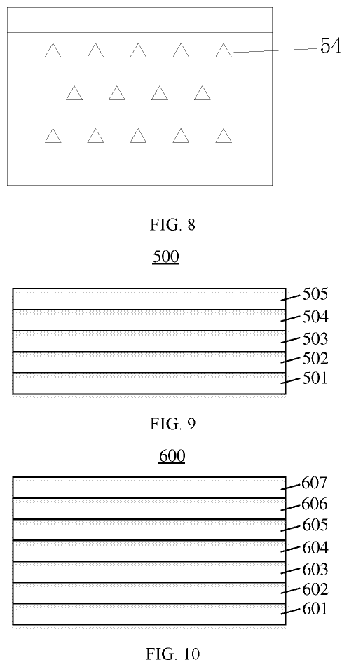

Continuously referring to FIG. 5, the penetration window 51 is a strip in shape. In other embodiments, as shown in FIG. 6, a plurality of penetration windows 52 are circular in shape and arranged in an array, and a diameter of the penetration window 52 is greater than or equal to 1 mm. As shown in FIG. 7, a penetration window 53 is S-shaped and a plurality of S-shaped penetration windows 53 are arranged in a row. A line width of the S-shaped penetration window 53 is greater than or equal to 1 mm, and a length of the S-shaped penetration window 53 is adaptive to a size of a surface. As shown in FIG. 8, a penetration window 54 is triangular in shape. Preferably, a plurality of penetration windows 54 are in a shape of a regular triangle and arranged in an array, and a height of the triangle is greater than or equal to 1 mm. Furthermore, the penetration windows of the transparent heating film may be arranged in a combination of various shapes. The penetration window may eliminate or reduce a shielding effect of the conductive grid to facilitate penetration of a signal.

Referring to FIG. 9 to FIG. 13, examples are provided to describe a heating glass. Referring to FIG. 9, a heating glass 500 includes a glass and a transparent heating film bonded to the glass. Specifically, the heating glass 500 includes a substrate layer 501, a conductive grid 502, an electrode 503, a bonding layer 504, and a glass 505. The conductive grid 502 is directly disposed on the substrate layer 501 (such as a PET layer); or a transparent imprinting resin is provided on the substrate layer 501, a groove is formed on the transparent imprinting resin, and a conductive material is filled in the groove to form the conductive grid 502. The electrode 503 is configured to be a part of the conductive grid 502, or may be formed on the conductive grid 502 through a method of screen printing. Furthermore, a plurality of penetration windows may be distributed in the conductive grid. The electrode 503 is electrically connected to the conductive grid, and the bonding layer 504 (such as an OCA layer, a PVB layer, or an EVA layer) is used to connect to the substrate layer 501 and the glass 505. In the present embodiment, the glass 505 is disposed as the uppermost layer, and in other embodiments, the glass 505 may be inverted to be the lowermost layer, which may be applied to other embodiments.

Referring to FIG. 10, a heating glass 600 includes two layers of glass and a transparent heating film disposed between the two layers of glass. Specifically, the heating glass 600 includes a glass 601, a bonding layer 602, a substrate layer 603, a conductive grid 604, an electrode 605, a bonding layer 606, and a glass 607, and a forming manner is as described above.

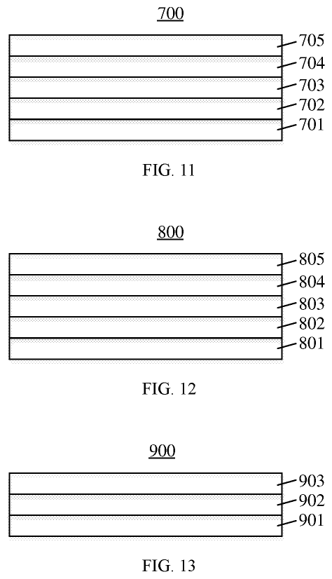

Referring to FIG. 11, a heating glass 700 includes two layers of glass and a transparent heating film disposed between the two layers of glass. Specifically, the heating glass 700 includes a glass 701, a conductive grid 702, an electrode 703, a bonding layer 704, and a glass 705. A trench may be directly formed on the glass 701, and a conductive grid 702 is formed after the trench is filled; alternatively, a transparent imprinting resin may be disposed on the glass 701, a trench is formed on the transparent imprinting resin, and a conductive material is filled in the trench to form the conductive grid 702. The electrode 703 may be provided as above. In the present embodiment, the glass 701 may be a part of the transparent heating film and play a role of a transparent supporting body, or may be a part of the heating glass.

Referring to FIG. 12, a heating glass 800 includes a glass and a transparent heating film bonded to the glass. Specifically, the heating glass 800 includes an electrode 801, a conductive grid 802, a substrate layer 803, a bonding layer 804, and a glass 805. The conductive grid 802 is disposed on a side of the substrate layer 803, the electrode 801 is disposed on the conductive grid 802 and electrically connected to the conductive grid, and a side of the substrate layer 803 opposite to the conductive grid 802 is bonded to the glass 805 through the bonding layer 804.

Referring to FIG. 13, a heating glass 900 includes an electrode 901, a conductive grid 902 and a glass 903. The conductive grid 902 is formed on the glass 903 directly or through a transparent imprinting resin, and the glass 903 serves as a transparent supporting body or a substrate layer. In the present embodiment, the heating glass 900 may be considered as a transparent heating film or the heating glass 900.

The transparent heating film is directly formed on a glass or is bonded to a glass through a bonding layer so as to form a heating glass. When the transparent heating film is provided with a glass layer, the transparent heating film may also be directly considered as a heating glass. The transparent heating film/heating glass of the present disclosure may be applied to the fields of transportation, architecture, and the like, and may be used to defrost, defog, and remove rainwater on an inner and outer surfaces of a window glass. The transparent heating film/heating glass is heated by using a conductive grid. A grid line with a depth-to-width ratio greater than or equal to 2 is adopted to form the conductive grid, and an average aperture ranges from 10 μm to 1000 μm, so that the transparent heating film/heating glass has effects of high transmittance, high signal penetration, low square resistance, and rapid heating, and more lights are allowed to penetrate without affecting observation and work of an inner personnel. And the conductive grid may achieve a rapid heating effect of reaching over 80° C. within 5-10 seconds. A penetration window is disposed in the conductive grid of the transparent heating film/heating glass, and the penetration window may be configured to be blank inside or configured with a color matching grid, and a minimum side length (diameter) of the penetration window is greater than or equal to 1 mm to facilitate penetration of a signal of a frequency band, so that a signal may easily penetrate and usage of a communication device may not be affected.

In order to make the above objectives, features and advantages of the present disclosure more comprehensible, specific embodiments of the present disclosure are described in detail above with reference to the accompanying drawings. Numerous specific details are set forth in the above description to facilitate a sufficient understanding of the present disclosure. However, the present disclosure may be implemented in many other ways different from that described above, and those skilled in the art may perform similar improvements without departing from the connotation of the present disclosure. Therefore, the present disclosure is not limited by the specific embodiments disclosed above. Moreover, the technical features of the above embodiments may be combined arbitrarily, and in order to make the description concise, all possible combinations of the technical features in the foregoing embodiments are not described. However, as long as there is no contradiction in the combination of these technical features, it should be considered as within the scope of the present specification.

The above embodiments only express several embodiments of the present disclosure, and the description thereof is more specific and detailed, but cannot be understood as a limitation on the patent scope of the present disclosure. It should be noted that, for those skilled in the art, several variations and improvements may be made without departing from the concept of the present disclosure, which are all within the protection scope of the present disclosure. Therefore, the scope of protection of the present disclosure shall be subject to the attached claims.

What is claimed is:

1. A transparent heating film, comprising:
a transparent supporting body, wherein a side of the transparent supporting body is provided with a plurality of trenches interconnected to each other in a grid shape;
a conductive grid, wherein the conductive grid is formed by filling the plurality of trenches with a conductive material; and
at least one penetration window, located between and partitioned with the conductive grid.

2. The transparent heating film according to claim 1, wherein the at least one penetration window comprises a plurality of penetration windows, and the plurality of penetration windows are randomly or regularly distributed between the conductive grid.

3. The transparent heating film according to claim 2, wherein the plurality of penetration windows are in one or more shapes of a triangle, a polygon, an S shape, and a circle.

4. The transparent heating film according to claim 3, wherein a minimum side length and/or a minimum width of the penetration window is greater than or equal to 1 mm.

5. The transparent heating film according to claim 3, wherein a width of the penetration window ranges from 1 mm to 10 cm.

6. The transparent heating film according to claim 1, wherein the penetration window is configured to be blank inside.

7. The transparent heating film according to claim 1, wherein the penetration window is provided with a color matching grid, and the color matching grid is not connected to the conductive grid.

8. The transparent heating film according to claim 7, wherein the transparent supporting body is provided with a groove, the groove is filled with a color matching material to form the color matching grid, and a grid line of the color matching grid is disconnected to form an open circuit.

9. The transparent heating film according to claim 7, wherein an average aperture of the conductive grid ranges from 10 μm to 1000 μm, and an average aperture of the color matching grid ranges from 10 μm to 1000 μm.

10. The transparent heating film according to claim 1, wherein a depth-to-width ratio of the trench is greater than or equal to 2.

11. The transparent heating film according to claim 1, wherein a width of the trench ranges from 500 nm to 10 μm, and a depth of the trench ranges from 1 μm to 20 μm.

12. The transparent heating film according to claim 1, wherein a part of the conductive grid is configured as an electrode; or the transparent supporting body further comprises a line-shaped trench, and the line-shaped trench is filled with the conductive material to form the electrode electrically connected to the conductive grid; or the transparent heating film further comprises the electrode stacked on the transparent supporting body and electrically connected to the conductive grid.

13. The transparent heating film according to claim 1, wherein the transparent supporting body is a substrate layer; or the transparent heating film further comprises the substrate layer, and the transparent supporting body is stacked on the substrate layer.

14. A transparent heating film, comprising:
a transparent supporting body, wherein the transparent supporting body is provided with a trench and a groove, the trench is not connected to the groove, and the trench is in a grid shape;
a conductive grid, wherein the trench is filled with a conductive material to form the conductive grid;
a color matching grid, wherein the groove is filled with a color matching material to form the color matching grid, and the conductive grid is not connected to the color matching grid; and
an electrode lead wire, wherein the electrode lead wire comprises an electrode electrically connected to the conductive grid, and a lead wire electrically connected to the electrode.

15. The transparent heating film according to claim 14, wherein a penetration window is formed by the color matching grid, and a plurality of penetration windows are distributed between the conductive grid.

16. The transparent heating film according to claim 14, wherein a depth-to-width ratio of the trench is greater than or equal to 2, and an average aperture of the conductive grid ranges from 10 μm to 1000 μm.

17. The transparent heating film according to claim 14, wherein the electrode comprises a first electrode and a second electrode disposed opposite to each other, the electrode is in a line or arc shape, and the lead wire comprises first lead wires located at two ends of the first electrode respectively, and second lead wires located at two ends of the second electrode respectively.

18. A transparent heating film, comprising
a transparent supporting body, wherein a side of the transparent supporting body is provided with a trench in a grid shape;
a conductive grid, wherein the trench is filled with a conductive material to form the conductive grid;
an electrode, electrically connected to the conductive grid; and
a penetration window, wherein at least one of the penetration window is distributed between the conductive grid, the penetration window is configured to be blank inside or configured with a color matching grid disconnected to the conductive grid, and a minimum side length/a minimum width of the penetration window is greater than or equal to 1 mm.

19. A heating glass, comprising a glass and the transparent heating film according to claim 1 stacked with the glass.

20. The heating glass according to claim 19, wherein the glass is configured to be a layer of glass and the transparent heating film is disposed on either side of the glass, or the glass is configured to be two layers of glass and the transparent heating film is disposed between the two layers of the glass.
